(19) United States
(12) Patent Application Publication
(10) Pub. No.: US 2002/0102975 A1
(43) Pub. Date: Aug. 1, 2002

(54) Electronic information delivery system and process including supplying of information about locations visited by users of portable identification cards and delivery of card user identification information to the visited locations

(76) Inventor: Gregory Allen, New York, NY (US)

Correspondence Address: Mark Montague, Esq., Cowan, Liebowitz & Latman, P.C., 1133 Avenue of the Americas, New York, NY, 10036, US

(21) Appl. No.: 10/004,560

(22) Filed: Dec. 5, 2001

Related U.S. Application Data
(60) Provisional application No. 60/251,610, filed on Dec. 6, 2000.

(51) Int. Cl. H04M 1/00

(52) U.S. Cl. 455/435; 455/432; 455/558

(57) ABSTRACT

A process and system of supplying information between a visited physical location and a user includes providing to a user a portable device having a device identification code stored on or in the portable device, associating an identity of the user with the device identification code of the portable device, disposing a reader within or near a physical location, the reader having an associated reader identification code, visiting by the user of the physical location, reading by the reader of the device identification code stored on or in the portable device, supplying to a control center the reader identification code and the device identification code of the portable device read by the reader, and supplying by the control center to the physical location the identity of the user associated with the supplied device identification code.

### RELATED APPLICATION

This application claims the benefit of U.S. Provisional Application Serial No. 60/251,610, filed Dec. 6, 2000. The disclosure of U.S. Provisional Application Serial No. 60/251,610 is incorporated herein by reference.

### FIELD OF THE INVENTION

The present invention is directed an electronic information delivery system and process including supplying of information about locations visited by users of portable identification cards and delivery of card user identification information to the visited locations. Specifically, the present invention involves the use of portable cards by consumers and other individuals, card readers capable of reading identification information stored on or in the cards, and a central processing system that communicates with the card readers and the card holders for various purposes. The present invention also establishes various advantageous relationships among the card holders, card readers and the central processing system.

### BACKGROUND OF THE INVENTION

Currently available systems and processes that utilize portable cards for one purpose or another generally are designed to achieve a specified result. For example, U.S. Pat. No. 6,047,270, which issued on Apr. 4, 2000 and is incorporated herein by reference, discloses the use of a bank or credit card for transactional purposes and additionally discloses providing electronic account security by performing a clearance check with the user prior to such electronic use.

As other examples, U.S. Pat. No. 6,085,976, which issued on Jul. 11, 2000 and is incorporated herein by reference, is directed to a multi-application card usable for various purposes, including using the card as a bank card, a travel card, a passport, an identification card and an admission pass. U.S. Pat. No. 6,070,147, which issued on May 30, 2000 and is incorporated herein by reference, is directed to utilizing a driver's license or other government issued card for the purpose of utilizing it as a frequent buyer redemption card. Information about card use is stored in a database that facilitates the redemption program. U.S. Pat. No. 5,590,197, which issued on Dec. 31, 1996 and is incorporated herein by reference, is directed to a so-called “cyber wallet” for use in electronic commerce. The cyber wallet generally is an expansion of the credit card and entails an intelligent system, such as a smart card, a personal digital assistant (PDA), a PCMCIA card or the like, with stored thereon a public key file used for encryption and decryption. The cyber wallet provides security over unsecured communication networks along with authentication of the consumer to the merchant and of the merchant to the consumer.

The portable cards that are utilized in the above-described processes and systems and other processes and systems are quite well known. Examples of currently available portable identification cards includes magnetic cards, optical cards and RF transmitters. Most credit cards and bank cards are magnetic-type cards having a magnetic strip thereon and which magnetically store various identification information. Known contactless cards and devices utilize either RF (radio frequency) transmitter and receivers or IR (infra-red) transmitters and receivers. An exemplary contactless card/card reader system is disclosed in U.S. Pat. No. 6,097,292, which issued on Aug. 1, 2000 and is incorporated herein by reference. Other technologies that may be employed include providing bar codes or other matter printed on the cards that can be read by appropriate readers.

Various currently available systems and processes also carry out various features that are described above, but without the use of portable cards. For example, U.S. Pat. No. 4,947,028, which issued on Aug. 7, 1990 and is incorporated herein by reference, is directed to an automated order and payment system for consumer transactions of goods and services and includes three major components including a central computer system, a product/service identification system, and an order computer terminal. In the disclosed process, companies offering products for sale are identified by unique codes that are contained in advertisements, such as newspaper advertisements, and particular goods are also identified in those advertisements by unique codes. The advertisements are optically scanned at the consumer's home, and then credit card information is provided to purchase the desired product. All communications are carried out via the Internet. U.S. Pat. No. 6,064,979, which issued on May 16, 2000 and is incorporated herein by reference, is directed to finding and serving consumer product related information over the Internet using manufacturer identification numbers. A consumer request is made via the Internet utilizing standard Internet browser programs. Product and service information are pre-registered with the system by symbolically linking the information's so-called universal product code (UPC) or the manufacturer's identification number (MIN) with the Uniform Resource Locators (URLs) (i.e., web-site addresses) of the information resources on the Internet. Upon user entry of a UPC code of products or services about which information is sought, the system provides to the user the addresses of web sites that provide information about the identified good or service. U.S. Pat. No. 5,629,678, which issued on May 13, 1997 and incorporated herein by reference, is directed to a personal tracking and recovery system in which a transceiver implanted within a person's body is capable of detecting biological information about the body and remotely transmitting that information to an external device. The location of the person with the implanted device can be tracked.

While many of the above-mentioned processes and systems and other currently available processes and systems are useful for various purposes, such as readily providing useful information to consumers, enabling efficient procurement of consumer transactions, and providing security and protection to consumers and businesses, such processes and systems are quite limited in nature. They generally are designed to carry out only a single function and the devices and processes thereof are not easily modifiable to provide useful results in a variety of applications.

### OBJECTS OF THE INVENTION

It is therefore an object of the present invention to provide a system and corresponding process that provides useful and desired information to consumers and other individuals in a convenient and efficient manner.

It is another object of the present invention to provide consumers and other individuals with the capability of receiving information about places visited in a convenient and efficient manner.

It is a further object of the present invention to provide information, goods and services to consumers and other individuals in a simple and convenient manner.

Various other objects, advantages and features of the present invention will become readily apparent to those of ordinary skill in the art, and the novel features will be particularly pointed out in the appended claims.

### SUMMARY OF THE INVENTION

In accordance with the present invention, a process and system of supplying information between a visited physical location and a user includes providing to a user a portable device having a device identification code stored on or in the portable device, associating an identity of the user with the device identification code of the portable device, disposing a reader within or near a physical location, the reader having an associated reader identification code, visiting by the user of the physical location, reading by the reader of the device identification code stored on or in the portable device, supplying to a control center the reader identification code and the device identification code of the portable device read by the reader, and supplying by the control center to the physical location the identity of the user associated with the supplied device identification code.

The process may also include identifying by the user of an information destination to which information is to be supplied to the user, associating the identified information destination with the device identification code of the portable device provided to the user, identifying to the control center information associated with the reader identification code and relating to the physical location, and supplying by the control center the information associated with the supplied reader identification code to the information destination associated with the supplied device identification code.

Visiting may be carried out by visiting an exterior of the physical location, and reading is carried out when the user is exterior to the physical location.

Visiting may be carried out by visiting by the user of the physical location when the physical location is closed, and reading is carried out when the physical location is closed.

The portable device supplied to the user does not identify the user.

Disposing the reader within or near the physical location may be carried out by disposing a plurality of readers within or near the physical location, each of the readers being disposed at a respective unit within or associated with the physical location and having a respective reader identification code.

The process may also include registering the user to the control center during which the user identifies an amount of identification information to be supplied to visited locations, and supplying by the control center is carried out by supplying to the physical location the identity of the user associated with the supplied device identification code in accordance with the user identified amount of identification information to be supplied.

Registering may include the user identifying a plurality of amounts of identification information to be supplied, the process also includes identifying by the user during visiting one of the plurality of amounts of identification information to be supplied, and supplying by the control center is carried out by supplying to the physical location an amount of identification information in accordance with the user identified one of the plurality of amounts of identification information to be supplied.

### BRIEF DESCRIPTION OF THE DRAWINGS

The following detailed description, given by way of example and not intended to limit the present invention solely thereto, will best be appreciated in conjunction with the accompanying drawings, wherein like reference numerals denote like elements and parts, in which:

FIG. 1 schematically illustrates the basic relationship between the various participants of the process of the present invention;

FIG. 2 schematically illustrates the direction and type of information conveyed between the participants in accordance with the present invention;

FIG. 3 schematically illustrates the process of the present invention in terms of the cardholder;

FIG. 4 illustrates the relationships created by the process of the present invention.;

FIG. 5 schematically illustrates the installations needed for the process of the present invention;

FIG. 6 sets forth methods of installation and supply of cards and readers in accordance with the present invention;

FIG. 7 sets forth the continued and furthered relationship between the participants involved in accordance with the present invention;

FIG. 8 schematically illustrates the involvement of a sponsor operating and communicating with the control center in accordance with the present invention;

FIG. 9 illustrates the process pertaining to a network of permission-based relationships among the various participants involved in accordance with the present invention;

FIG. 10 illustrates distributions of cards and readers in accordance with the present invention;

FIG. 11 illustrates a network of relationships in accordance with the process of the present invention; and

FIG. 12 illustrates the process from the perspective of the sponsor in accordance with the present invention.

### DETAILED DESCRIPTION OF THE INVENTION

The inventive process described herein will first be described in general terms and generally without reference to any exemplary application thereof, except where necessary to sufficiently describe the sub-processes and features of the present invention. After this description, specific embodiments, applications and examples are provided.

As used herein, the term “Keylink” is a novel process for establishing a whole new kind of mediated information relationship with a consumer population. Keylink enables countless business applications and is rich with alliance/partnership possibilities. As also used herein, the term Keylink refers to both the general process and the organization (i.e., entity, physical system—control center, etc.) that takes on the central mediation/fulfillment role. At the heart of the Keylink process is the use of a portable identification card, such as cards that are used to access buildings and offices, or cards that are disclosed in any of the above-mentioned patents, or any other known card that would be appropriate for the present invention described herein. As will be appreciated, the characteristics of the cardholder and the card reader site can vary widely from application to application, but the applications all involve the same underlying Keylink process.

The drawings of the present invention depict several aspects of the process, including information flows, flows of identification cards and readers, and relationships among the participants in the process. As is appreciated, participants of the disclosed process can include consumers, retail stores and other types of businesses, Keylink (e.g., the control center), as well as various other organizations and entities, such as sponsors of the Keylink process described herein.

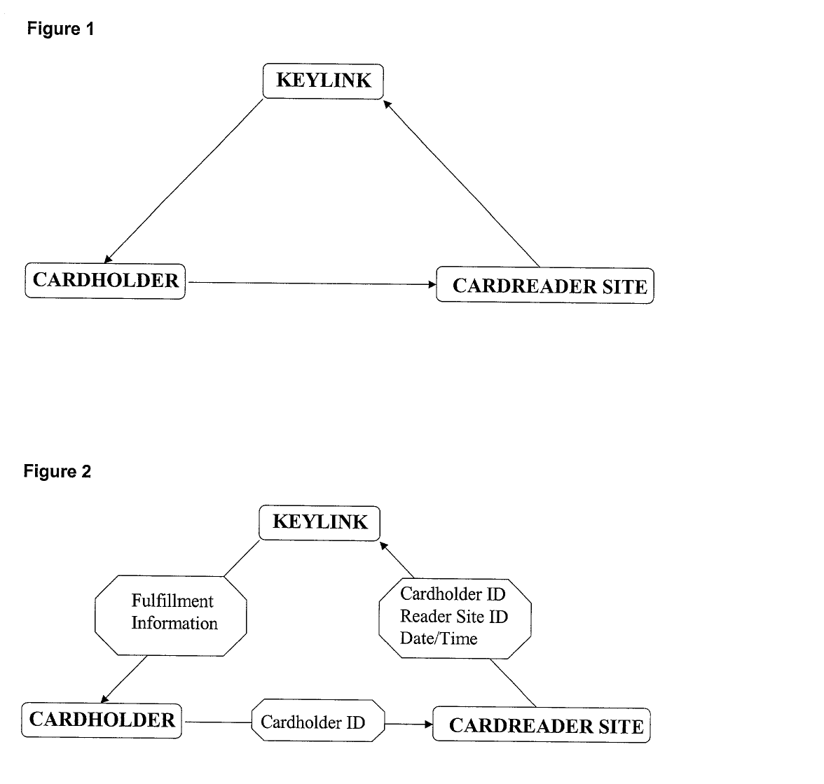

Referring now to the drawings, FIG. 1 schematically illustrates the basic relationship between the various crucial participants of the present invention. These participants include the cardholder, a card reader site and the central control system (for convenience, “Keylink” in the drawings and description).

The relationships between and the functions of the participants described herein achieve various total functions and results that have not been previously achieved. As will be discussed, a cardholder may be a consumer of products or services, a tourist visiting a city, a visitor to an interesting site or facility, such as a museum, or simply an individual seeking to obtain information about something he/she has seen. Potential card reader sites are numerous, and may include retail stores, museums, government facilities, residential homes, etc. Generally, any location about which information may be desired can be a card reader site. The Keylink facility represents the entity that essentially controls and facilitates the novel process described herein. Such facility generally is one or more computer systems that is able to communicate with the participants in the manner described below.

FIG. 2 schematically illustrates the direction and type of information that is conveyed between the participants. As shown in FIG. 2, an identification code or “cardholder ID” is supplied from the cardholder to a card reader site. In the preferred embodiment of the present invention, a card held by an individual contains (i.e., has stored thereon or therein) only a unique identification code (“ID code” or, for convenience, “card ID”), and the card reader site contains a card reader that is capable of reading or receiving this ID code. The card reader then supplies to a third party, that is, the control center, the card ID as well as any additional information needed to identify the card reader and/or the card reader site, such as the card reader ID (also called reader site ID). Date and time information may also be provided. In the last step of the basic Keylink process, so-called fulfillment information is provided by the control center to the card holder.

In brief, the novel process of the present invention allows a cardholder to receive tailored information that is triggered by, for example, the “swipe” of a wireless identification card across a reader. The information supplied to the card holder is tailored based on the identity of the cardholder, the location of the reader, and perhaps the date and time the swipe occurs. The information provided to the Cardholder is supplied by a control center implementing the entire process.

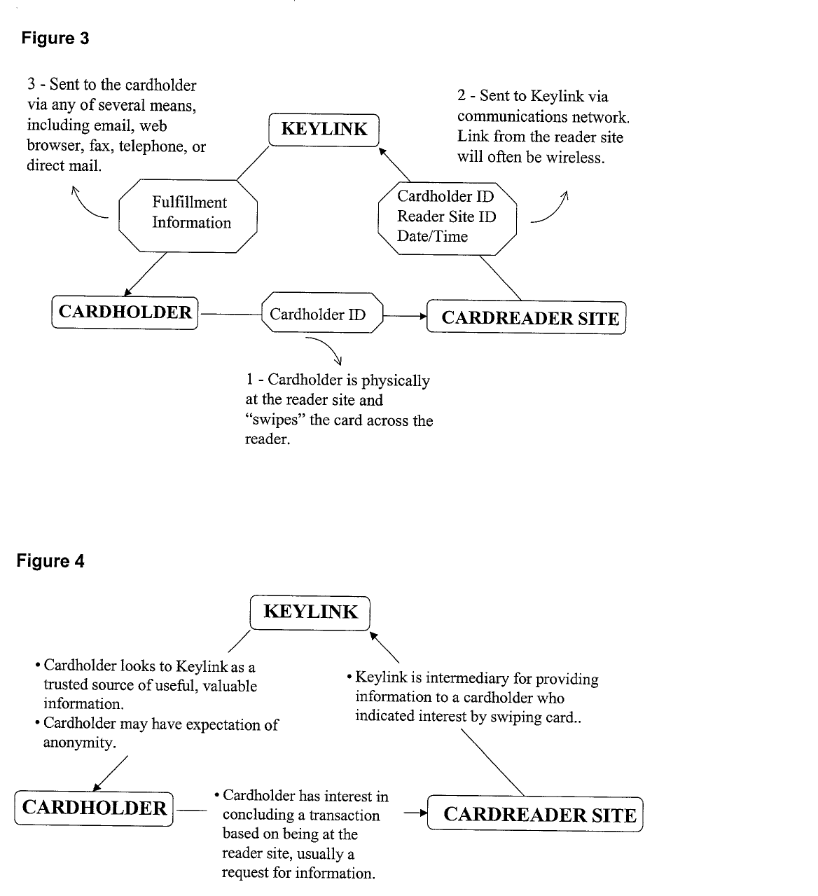

FIG. 3 illustrates that the fundamental process of the present invention both begins and ends with the cardholder. FIG. 3 illustrates the three basic steps involved to carry out the basic process of the present invention. First, in step 1 of the process, a cardholder physically approaches a reader and allows the reader to read the card ID (e.g., the card is “swiped” through the reader). In step 2, the reader transmits certain information, including the card ID, reader ID and possibly the date and time, to the central Keylink processing site. Based on the supplied information and information previously stored at the processing site (further discussed below), Keylink (in step 3) determines what fulfillment information is to be sent to the cardholder and then sends such fulfillment information to the cardholder in a manner identified or requested by the cardholder (also further discussed below). For example, the fulfillment information can be supplied to the cardholder via e-mail, facsimile, telephone or post. Alternatively, the cardholder can access the information via a pre-designated web site that is accessed by the cardholder.

FIG. 4 illustrates the relationships that are created by the process of the present invention. As shown in FIG. 4, several relationships are established by the process. First, the cardholder generally has an interest in conducting a transaction, whether informational based, financially based, etc., with the reader site. In one embodiment discussed below, such transaction is purely informational based. The reader site has a previously arranged relationship with Keylink as an intermediary to service cardholders' desires. Upon reading a card ID, the reader site's relationship with Keylink is for Keylink to provide specified information about the reader site to the particular card holder. Finally, the cardholder, by utilizing the identification card, expects Keylink to be able to provide useful and valuable information about the reader site. The cardholder has further expectations, including confidentiality, security, etc., as will be set out in greater detail with regard to particular embodiments of the present invention.

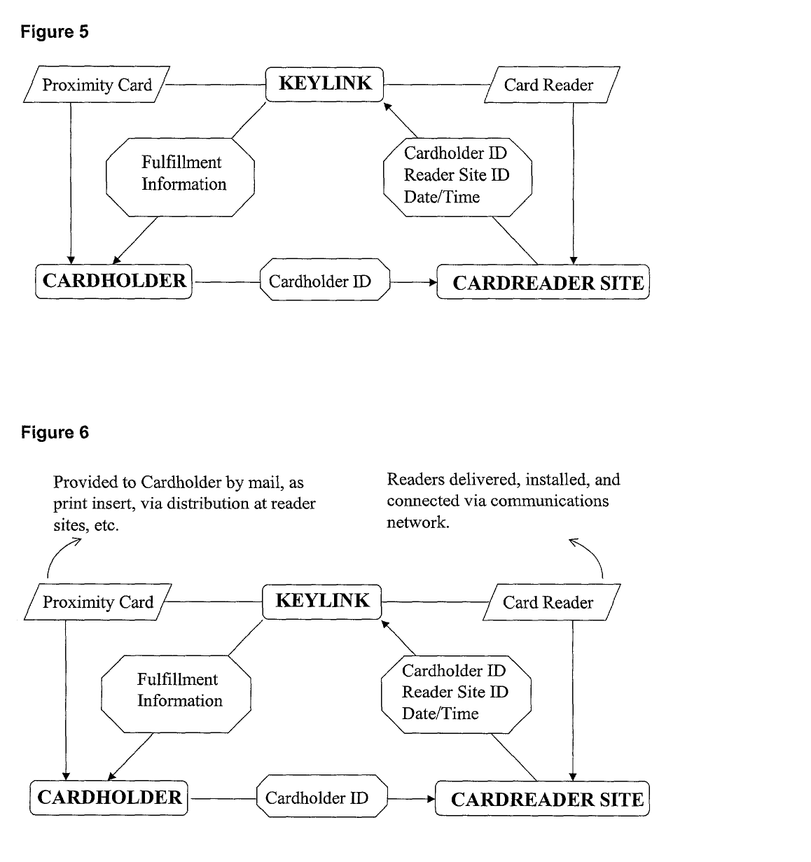

FIG. 5 schematically illustrates the basic installations needed for the novel process to be carried out. This generally involves the supply of the ID cards (i.e., the cards carried by the cardholders) to individuals and the supply of card readers to particular sites.

As is appreciated, cards and readers are needed to implement the process described herein. The manners of distribution, installation and/or supply of these cards and readers varies based upon the particular embodiment of the present invention. Thus, such manners are deemed to constitute a part of the novel process described herein.

FIG. 6 sets forth general methods of installation and supply of cards and readers and, for convenience, such installation and supply are carried out by the control center (i.e., “Keylink”). As shown in FIG. 6, cards may be distributed to cardholders via mail or may be included within printed material supplied to individuals, or may be distributed to persons at the reader sites. Various embodiments and examples describing distribution of cards in further detail is set forth below. Likewise, distribution and installation of readers may be performed in various manners, and generally is determined by the particular application involved. For example, the readers may be installed at sites upon registration of sites (discussed in detail below), whereupon such readers are installed and connected to a communications network. The communications network involved may be the Internet, an intranet, the public telephone system, or any other type of network.

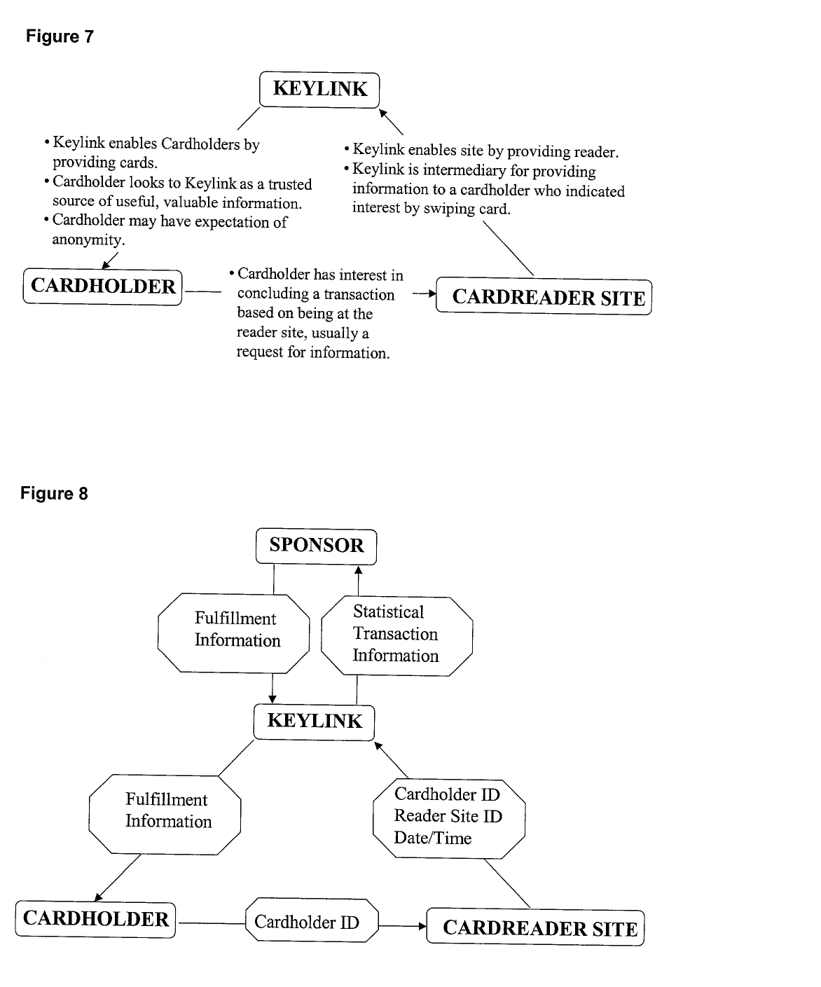

FIG. 7 sets forth the continued and furthered relationship between the participants involved. As illustrated in FIG. 7, distribution of cards and readers adds a “dimension” to the relationship between the participants, Keylink, cardholders and reader sites. In the illustrated diagram, Keylink is the source of the cards and readers and Keylink enables the other participants with information, and also operates as the intermediary.

FIG. 8 schematically illustrates the involvement of a so-called sponsor who operates and communicates with Keylink to enable the present invention. With reference to FIG. 8, the range of applications for the process described herein increases due to the addition of a major participant—a sponsor. The sponsor may carry out various functions otherwise performed by Keylink and/or may carry out additional functions. In one example, the sponsor is the source of the fulfillment information upon initiation of the herein described process. The sponsor may achieve additional functions not yet described, such as the receiver of statistical information about the ensemble of transactions taking place. Such statistical functions and features of the present invention are discussed in detail below as parts of various embodiments of the present invention. The sponsor may achieve functions distinct and remote from the functions carried out by Keylink. For example, as described in various embodiments of the present invention, the sponsor may be the operator of a tourist location such as a museum, wherein visitors are afforded the opportunity of experiencing exhibits in various novel ways. Other examples also are provided in greater detail below.

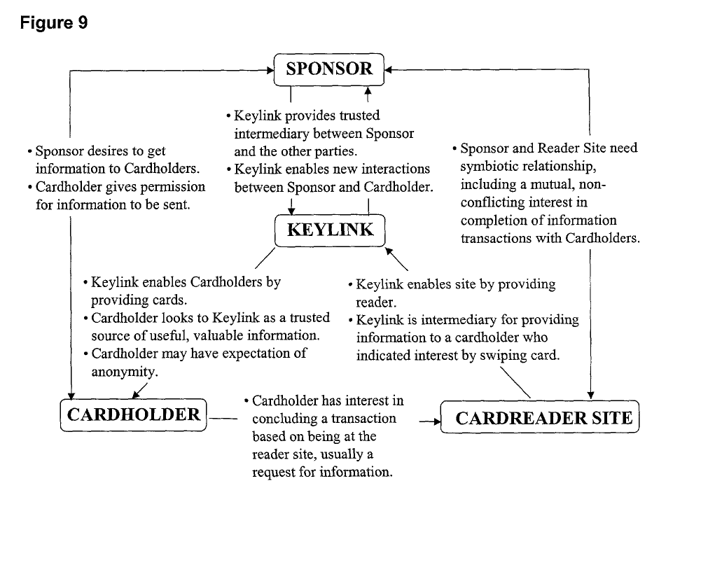

FIG. 9 illustrates how the process described herein enables and mediates a network of trusted, permission-based relationships among the various participants involved.

The richness of the applications made possible by adding a sponsor become evident in the new relationships that now exist between the sponsor and the cardholders and reader sites. The sponsor has a “permission based” information relationship with the cardholder, creating a more receptive frame of mind in the cardholder. The sponsor and the reader site have a mutual, non-conflicting interest in the cardholder and in the completion of the transaction. There are many ways this can happen, including licensing of reader sites by the sponsor.

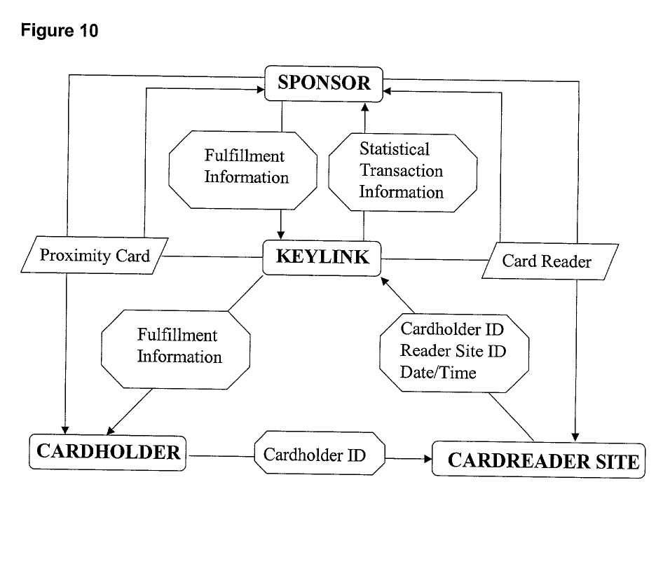

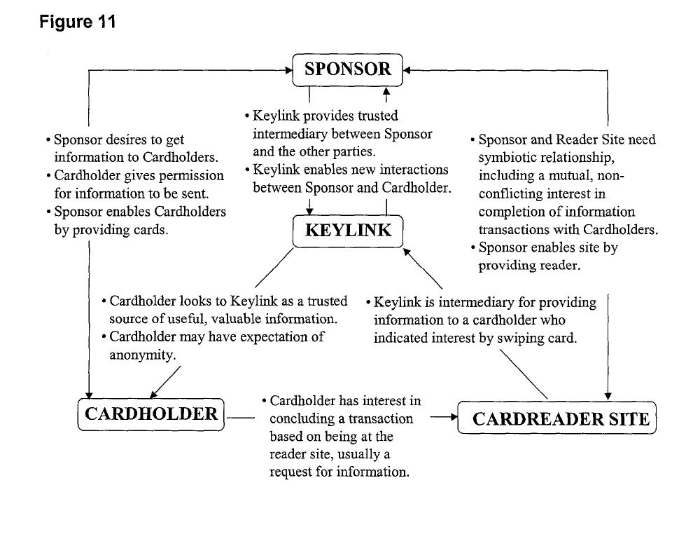

FIG. 10 illustrates how the sponsor distributes cards and readers, thereby increasing the sponsor's exposure. FIG. 10 shows how a sponsor can be directly involved in distributing cards and/or readers.

FIG. 11 illustrates a complete network of “information based” relationships, all relating to the Keylink process of the present invention.

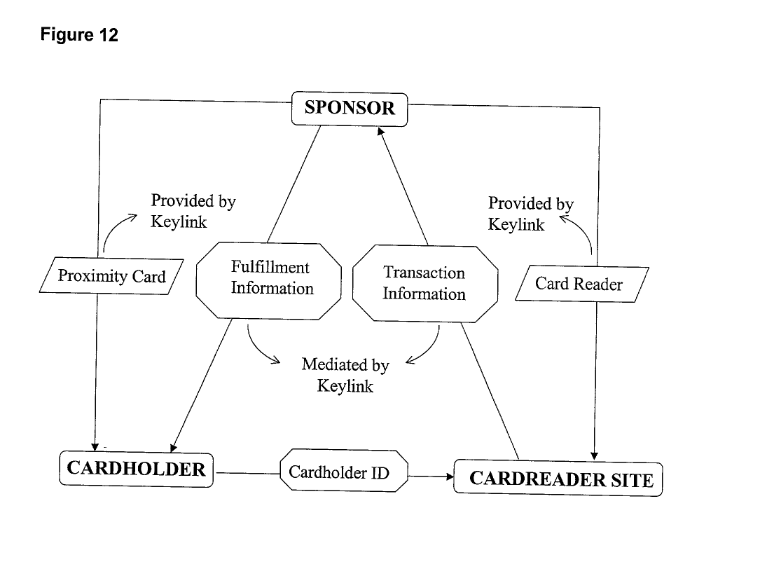

FIG. 12 illustrates the process from the perspective of the sponsor. In the potential relationship shown in FIG. 12, cards and readers are distributed by the sponsor, but are provided to the sponsor by Keylink.

FIGS. 9-12, previously discussed, illustrate various relationship and functions that are carried out by the combination of a control center (“Keylink”) and a separate entity identified herein as the sponsor of the process of the present invention. In practical applications, the functions that are carried out to enable the present invention, aside from the card and reader (and cardholder and reader site), will be achieved by multiple entities utilizing a variety of technologies and devices. The specific technologies and devices involved are considered to be well known in the art and the functions and features described herein all may be implemented by currently available technology and systems. Of course, all of the functions that can be carried out by both Keylink (i.e., the control center) and the so-called sponsor may be achieved by a single entity.

For convenience hereinafter, the novel process of the present invention will be described in terms of ID cards (or simply “cards” or “portable devices” or the like), cardholders (or “users”, “visitors”, etc.), readers, reader sites and a single control center (or other suitable term for the control center). Various technologies may be employed for the cards, readers and control center, and examples are provided below. Of course, technologies and devices not mentioned herein may also be utilized if such can be utilized to enable the invention.

Particular embodiments of the present invention, as hereinafter discussed, refer to the various participants involved. Such participants previously mentioned include cardholder, reader site, control center and sponsor. It should be understood that references to “consumers” refer to the previously described cardholders, references to “stores” refer to the previously mentioned reader sites, or simply physical locations at or in which a card reader is disposed, and references to “processing center,” “processing site” or the like refer to the previously mentioned control center. It also should be understand that references to a “site” or “sites” generally refers to a physical location and not a web site, unless otherwise indicated.

Fundamentally, the present invention involves the following five (5) types of tangible elements: (1) ID cards; (2) cardholders; (3) reader sites; (4) card readers; and (5) the control center. As previously set forth, the general process of the present invention is directed to the use by a cardholder of an ID card having stored therein (or thereon) a unique identification code (card ID) for the purpose of obtaining information. The card is “used” by the cardholder by allowing the card ID stored in the card to be read by a card reader disposed at a reader site.

Card readers are disposed at particular sites (i.e., locations) located remote from the cardholder's home or business, as further discussed below. Each card reader has associated with it a unique reader ID code (for convenience, reader ID). When a reader receives a card's ID code (when a card is utilized), the reader supplies the card ID and the reader's ID (and preferably date and time information) to the control center via any suitable mode of travel (discussed below). The control center then completes the basic process of the present invention by supplying generally useful information about the reader site to a destination designated by the cardholder.

Use of the card depends on the technology employed. For example, the cards may include magnetic strips having stored therein a respective unique ID code and, thus, a card is used by swiping it through a suitable reader. As another example, the cards may be smart cards or PCMCIA type cards, wherein a card is used by coupling it to a suitable port disposed within a device that interacts with the card once coupled. The cards may also be in the form of an RF transmitter (or, alternatively, an IR transmitter), which transmits the stored ID code when in close proximity to a suitable RF receiver. The particular shape and size of the card is not pertinent to the invention described herein, so long as they are appropriately sized to be portable and carried for use by consumers and other individuals. For example, the “card” as discussed herein may be a relatively small and narrow case (e.g., suitable for attachment to a key chain) that contains therein an RF transmitter. As another example, the “card” may be in the form of a small flashlight capable of projecting a narrow beam of visible (or invisible) light that includes encoded therein the card's ID code thus enabling a suitable reader to receive the ID code.

The method of communication between a reader site and the control center and between the control center and a cardholder's designated site (e.g., the cardholder's computer) may be achieved in any known manner including use of the Internet (e.g. e-mail, communication to a web-site, etc.), a public or private telephone network, whether via a land-line telephone or a cellular telephone, intranet, regular mail, whether a government provided mail service or a private mail service, etc., or any combination thereof.. Such methods of communication are further discussed below.

1. Consumer/Retail Store

In one particular embodiment of the present invention, one or more card readers are disposed within or adjacent to retail stores, and consumers are each provided with an ID card. The control center maintains a database of information about each of the distributed card readers and about each of the distributed ID cards. Within the database, a card reader is identified by its respective reader ID, and associated with each reader ID is the identity of the site (i.e., retail store) at which the reader is disposed, and the fulfillment information that is to supplied to a consumer upon consumer use of a card at the respective reader. Each reader ID may be associated with additional information, as set forth in the various aspects of this embodiment discussed below.

The control center's database also identifies each distributed card by its respective card ID, and associated with each card ID is the identity of the holder of that card (i.e., consumer) and the location to which fulfillment information is to be sent upon use of the card. A card ID may be associated with additional information, such as consumer preferences, as set forth in greater detail below.

In accordance with the present invention, consumers are provided with ID cards, and retail stores located, for example, along a street within a city or town are provided with readers. Each reader is installed and designed to communicate with the control center via, for example, the Internet each time a reader receives (i.e., by reading) a card ID. A consumer holding a card then utilizes the process described herein by simply walking down this street and selecting those stores about which information, such as a store catalog, is desired. When the consumer passes by such a store, he or she carries out the task of having his/her card read by that store's reader. The reader then initiates a communication to the control center by supplying to the control center the read card ID, the reader ID and preferably the current date and time. The control center identifies the fulfillment information associated with the supplied reader ID, identifies the consumer's designated location to which fulfillment information is to be sent, and then supplies the identified fulfillment information to the designated location. All of these functions are carried out by the control center without any additional consumer involvement. In the meantime, the consumer can continue to the next store without any further effort needed to obtain the desired information about the retail store just visited. If the consumer designated an e-mail address as the location to which fulfillment information is to be sent, then the desired information is obtained upon the consumer later viewing his/her e-mail. If the consumer designated a telephone number of a facsimile machine as the preferred means of receiving information, then the consumer simply needs to access the designated facsimile to obtain the desired information.

As an aspect of the present invention, the fulfillment information is supplied to a consumer as a result of a non-retail transaction, that is, without the consumer conducting a purchase of any product or service from the retail store visited. However, various embodiments discussed below pertain to retail transactions.

Features of Consumer/Retail Store Embodiment

a. Location of Readers

As a feature of this embodiment of the present invention, retail stores can provide their readers at locations accessible to consumers where consumers need not enter the stores to have their card IDs read. Thus, the present invention enables consumers to obtain information about retail stores without requiring those consumers to enter those retail stores. This is an advantageous feature and overcomes the current problem of not being able to obtain information about stores physically visited when those stores are closed. It also overcomes the problem of obtaining information about visited stores without requiring interaction with store sales persons and other store representatives and agents.

Further, information about visited stores is obtained in a manner that is, from the consumer's point of view, non-technical and that does not necessarily require use of the Internet. Thus, an individual who seeks information about a retail store or business need not conduct any Internet searching, which is generally required for most, if not all, currently available automated searching and information systems.

The present invention, for the consumer/retail store embodiment and for most other embodiments discussed below, provides the advantageous features of confidentiality and security to the consumer. The consumer obtains information by utilizing an ID card. However, since the ID card only contains a ID code and does not identify the consumer or any proprietary information about the consumer, nothing is lost if the ID card is lost or stolen. The consumer simply obtains a replacement ID card with a new, unique ID code stored thereon or therein. Moreover, a lost or stolen ID card has absolutely no value to another individual. As for confidentiality, the consumer is enabled to obtain information about a retail store without supplying his/her identity (including name, address, telephone number, etc.) to that retail store. Only the control center maintains the identity of the consumer, and retail stores and other businesses are not informed of the identities of the visiting consumer, unless a consumer so chooses (e.g., during registration, as further discussed below). Thus, so-called identity theft is prevented, whether attempted by store employees or any other individual. In addition to confidentiality and security, the present invention advantageously enables consumers to obtain information about visited stores in a convenient and efficient manner, obviating any need for consumers to fill out forms or otherwise supply his/her home addresses and/or telephone numbers, and/or interact with salespersons and other employees of the site being visited.

b. Multiple Readers within Retail Stores

In addition to providing each retail store or business with a single reader, businesses may be provided with multiple readers for the purpose of placing a reader, for example, within each of the departments of the retail store. In such case, the control center associates each reader ID with an identified retail store or business and with a particular department (or sub-department, etc.) of that retail store. Then, the fulfillment information associated with a respective reader can pertain to information specific to the respective store department visited. As an extension of providing multiple readers to a single retail store, readers can be associated with individual store products where the fulfillment information pertains to a particular product. Consumers visiting a retail store then are enabled to select only those departments (sub-departments, etc.) and/or products (or group of products) about which information is desired. As a variation, multiple readers can be disposed outside a retail store (or behind a display window), with each reader being identified with a respective store department, or product, or group of products (e.g., televisions), thus enabling consumers to obtain specific information about the retail store's products without requiring the consumer to browse the store. As used herein, if multiple readers are provided within a single store, then each reader can be said to be associated with a respective element of that store, with such element being a respective department, a respective sub-department, a respective product, a respective group of products or other appropriate group or item pertaining to the store.

c. Customization by Consumer of Information to be Received

As discussed above, fulfillment information provided to consumers may be in the form of a store catalog or about information concerning a store department or about a particular product sold by a store. In each of these cases, the fulfillment information provided is a function of the particular reader that reads the consumer's ID card and the retail store's determination of what information is to be provided for each of the store's readers. As a feature of the Consumer/Retail Store embodiment, as well as most other embodiments discussed below, a consumer can identify the type and amount of information to be supplied by the control center. For example, the consumer can indicate, during registration discussed below, a preference for a minimum, average or maximum amount of information (or other suitable designation). The consumer may further indicate whether audio and/or video (e.g., still or motion picture) information is to be received, when applicable. Other consumer designations may include color or black and white preference of photographs of products, whether detailed descriptions and/or specifications about products are to be supplied, and whether information ancillary to the products are to provided. Many consumers prefer limited amounts of information, whereas other consumers prefer to receive as much information as possible. Consumer customization of the information to be received advantageously enables consumers to receive exactly what they want.

d. Initial Consumer Registration

Consumers can supply the above-mentioned preference information and identification information, such as name, address, telephone, e-mail address, etc., of the consumer during a consumer registration process that occurs, in one embodiment of the present invention, prior to the supply of the ID card to the consumer. In this embodiment, the control center or other entity obtains consumer information through a registration process, wherein the consumer is supplied the ID card only upon completion of registration. A consumer may initiate registration by, for example, accessing a particular web site and requesting to be registered in order to receive an ID card. Other known methods are available, such as the consumer contacting via telephone the control center (or other entity) or by completing a form.

During registration, the consumer supplies various identification information such as name, address, telephone number, e-mail address, etc. The above-discussed preference information also may be provided. The consumer further identifies the manner in which the fulfillment information is to be provided, whether by e-mail, post (regular mail), telephone or by retrieval from a particular web site by the consumer, or other known method of communication of information. Optionally, a consumer, if desired, can provide a second location to which the fulfillment information is to be provided, such as a friend's e-mail address, so that both the consumer and another designated individual receives the desired information. The consumer may further designate whether he or she would like to periodically receive information about the retail store or business visited. If so, the consumer can indicate whether the control center has permission to supply the consumer's identity to the visited retail store for the purpose of placing the consumer on the retail store's mailing list. To remain anonymous to the retail store, the consumer can alternatively request that the control center automatically, periodically supply to the consumer the fulfillment information about a visited retail store. In such case, when a consumer's ID card is read by a reader, the control center adds the consumer's identity (e.g., card ID) along with the reader ID on a list that represents a recurring supply of fulfillment information. Such fulfillment information may be supplied daily, weekly, monthly, quarterly, semi-annually, annually or other recurring period of time, or whenever the fulfillment information changes.

Consumers during registration may provide additional information to the control center, such as so-called purchasing options, which are discussed in a different section below.

e. Consumer Registration After Receipt/Use of ID cards

In the previously described section, consumers register and then receive ID cards. Alternatively, consumers can receive ID cards prior to registration. In accordance with this embodiment of the present invention, consumers can be supplied with ID cards in various manners. In one such manner, consumers receive ID cards on a random basis, such as by “mass-mailing” ID cards to unknown consumers. In another manner, “directed” consumers (i.e., those more inclined to use the cards as determined by, for example, a marketing company) receive ID cards. In a further manner, cards are given to individuals shopping in, for example, a shopping center, an indoor mall, etc. Also, cards can be left in trays within stores and other areas that freely can be taken by consumers. As is appreciated, the present embodiment is intended to enable the process of the present invention regardless of the manner of distribution of the ID cards.

No matter the manner of distribution, each distributed ID card has stored thereon (or therein) a unique card ID (as previously discussed). Accompanying each distributed ID card, appropriate literature may be provided that instructs the recipient in the manner of use of the received card (as previously discussed) and identifies the benefits that are provided by using the card. In addition, the recipient is instructed in the manner of registration that must be performed for the recipient to “activate” the card. Other useful information may be provided, as needed. Moreover, none, some or all of this information may be printed on the card itself. Preferably, at least a telephone number to call and/or a web site address to access to initiate the registration process is printed on the card so that distribution of the card itself is sufficient to enable use of the card by the consumer.

After distribution of cards in accordance with this embodiment of the present invention (i.e., prior to registration), consumers can then register to “activate” the cards. Consumer registration is achieved in the manner previously discussed (as in the case of consumer registration prior to distribution of cards). But in addition to providing the previously described consumer information, the identity of the card itself, held by the consumer, needs to be supplied to the control center, which may be done by printing a unique code on the card or accompanying literature and providing that unique code by the consumer to the control center. Preferably, the unique code (called, for example, registration code) printed on the card (or literature) is different from the card ID stored on or in the card. The control center then associates a distributed card (using its card ID) with the consumer who has now registered. The consumer then utilizes the card in the same manner previously discussed (e.g., by visiting stores and having readers read the card ID).

Upon receipt of a card by a consumer (prior to registration), the consumer can begin “using” the card prior to registration in accordance with an aspect of this embodiment of the present invention. Specifically, the process of the present invention entails distribution of a card to a consumer or other individual, use of that card by the consumer by having the card's ID read by a card reader, and then supply by that card reader to the control center of the read card ID and the reader ID (and, perhaps, date and time information). The control center identifies the fulfillment information that corresponds to the reader ID (as previously discussed), but the identity of the consumer using the card can not be determined since consumer registration has not yet occurred. In this instance, the control center awaits consumer registration before supplying the identified fulfillment information. Here, the consumer can continue to utilize the card, but in order to obtain any benefit from using the card (i.e., receive the fulfillment information), the consumer will need to register by contacting the telephone number or web site address preferably identified on the card, or register in any other manner. While relatively slow as compared to other methods, registration can be completed by the consumer completing a printed form and then sending the completed form via facsimile or by mail to a designated address.

As discussed above, consumer registration can occur prior to distribution of one or more cards. Consumer registration can also occur after distribution of cards. In the case of when cards are distributed prior to consumer registration, consumers then may register before using the cards or may begin using the cards and register afterwards. In accordance with the present invention, any of these variations can occur simultaneously and without any need to identify the particular variation utilized. That is, distribution of cards, consumer registration and card use are considered to represent independent acts, and registration and card use may occur in any order. Of course, registration is generally required only one time per card. While the process of supplying specific fulfillment information to a specific consumer can not be carried out without both consumer registration and card use, the result is the same independent of which occurs first. Thus, the present invention advantageously allows for various manners of distribution, registration and use of ID cards without imposing any additional, substantial constraints on the process described herein or the control center carrying out the final process of supplying fulfillment information.

f. Initial Reader Site Registration

Like consumer registration, a site that is to obtain one or more card readers needs to supply certain information to the control center to enable the control center to implement the supply of fulfillment information to the consumer. This may be accomplished during a registration process, where a retail store or other business entity supplies to the control center its name, address, telephone number, facsimile number, e-mail address, web site home page, etc., prior to the retail store's receipt of one or more readers. In addition to providing general identification information, the retail store can provide information about other related stores and chains, dates and times of operation, general descriptions of the products sold, the nature of the business, and any other potentially useful information.

During reader site registration, the retail store can establish the manner in which fulfillment information, for each of the readers, is to be supplied to the control center. If more than one reader is to be provided to the retail store, the following information can be the same for all of the readers or can be customized per reader, so as to provide maximum flexibility, efficiency and effectiveness. The retail store identifies how the fulfillment information is to be transferred to the control center, whether by e-mail, post, telephone, accessing by the retail store the control center's database (e.g., by automatic connect or via the Internet), or by any other known method of transmission of information. Alternatively, the retail store can maintain the fulfillment information at its own web site or other computer based system, where the control system is instructed to access the retail store's database or web site (or other location) to retrieve particular fulfillment information each time such information needs to be supplied to a consumer.

The retail store further indicates the type of information that will constitute the fulfillment information and/or other type of information, such as store catalog, announcements, promotional material, advertisements, etc, or any combination thereof. Also during registration, the retail store can provide the actual, current fulfillment information that corresponds to a respective reader, thus enabling the control center to immediately supply the consumer desired information upon the initial read by the retail store's reader.

The retail store can designate how often and the manner in which fulfillment information for the respective reader is to be revised and/or updated. The retail store can indicate that fulfillment information is to be updated, for example, monthly (or daily, weekly, etc.) and further indicate that the updated information will be stored at, for example, a particular web page (or pages) of the retail store's web site, or, alternatively, be supplied by the retail store (or other entity) to the control center. In the first case, the control center each month will automatically retrieve the updated fulfillment information for a designated reader or readers for that retail store. The retail store also can indicate that the fulfillment information will not be automatically updated, but only when manually updated by the retail store, for example, by the retail store supplying an e-mail to the control center identifying the reader ID and the new fulfillment information. If periodic update is indicated, the control center can be requested to provide the retail store with appropriate reminders and requests at appropriate intervals of time. Alternatively, the retail store can indicate that the fulfillment information will be provided by the store's reader with each card ID and reader ID after a consumer's ID card is read. Then, the store's card reader requires the additional capability of supplying the fulfillment information with each transmission to the control center. As a potential feature of any of the above possible methods of transmitting fulfillment information to the control center, one or more readers can further provide to the control center, along with a card ID and the reader ID, so-called supplemental fulfillment information, such as specials (e.g., one-day sales, promotions, etc.) and availability of items.

Complementing consumer registration, the retail store can select the option of requesting whether the consumer would like to be added to the retail store's mailing list.

g. Reader Site Registration After Distribution/Use of Readers

In the previously described section, retail stores register and then receive readers. Alternatively, and similar to the distribution/use of ID cards, retail stores can receive one or more readers prior to registration. In accordance with this aspect of the present invention, retail stores and other sites can be supplied with readers in various manners. Retail stores can be supplied with readers on a random, pseudo-random, or specific basis. For example, during a development phase of card and reader distribution, a certain percentage (e.g., 25%) of all retail stores located within a city, town, village, etc., are supplied with one or more readers. Or, all stores selling a certain type of product (e.g., clothing) are supplied with readers. Or, all or designated stores located on designated streets or in an indoor mall, and so on, are supplied with readers. Retail stores can also request readers. Other manner of distribution are possible.

No matter the manner of reader distribution, each distributed reader has a reader ID associated with it (as previously discussed). Accompanying each distributed reader is appropriate literature that instructs the recipient (e.g., retail store) in the manner of installation of the reader. The recipient also is instructed in the manner of registration that must be performed to enable distribution of fulfillment information pertaining to the retail store. This reader site registration has been previously discussed. However, and similar to cards distributed prior to registration, the reader must be identified, for example, by printing on the reader itself (or accompanying literature) the reader ID or other unique code.

In accordance with the present invention, a distributed reader can be installed and “used” (i.e., reads a card ID and supplies the read card ID and reader ID to the control center) prior to registration of the reader site. In such case, the process of the present invention entails distribution of a card to a consumer or other individual (before or after registration), use of that card by the consumer (before or after registration) by having the card's ID read by the reader of the not-yet registered reader site, and then supply by that card reader to the control center of the read card ID and the reader ID (and date and time information). If consumer registration has already occurred, then the control center can identify the consumer to which fulfillment information is to supplied. However, since reader site registration has not yet occurred with respect to the supplied reader ID, no fulfillment information has been supplied to the control center or otherwise identified. In this instance, the control center awaits reader site registration before supplying the identified fulfillment information to the identified, registered consumers. Readers thus can be installed and continued to be used in the herein-described process, but no fulfillment information is supplied to consumers until after reader site registration.

As discussed above, reader site registration can occur prior to distribution of one or more readers, or after distribution of those readers. Those readers can also be utilized before or after such registration. As is appreciated, this flexibility along with the flexibility afforded by the various orders of distribution, use and registration of ID cards, advantageously allows the process of the present invention to be applied to a great number of applications. The above-described retail store embodiment, as will be appreciated, represents only one such application. Various other applications are further discussed below.

h. Supply of Fulfillment Information to Consumer

As previously discussed, the supply of fulfillment information to the consumer automatically is carried out upon reading the ID code of the consumer's card. The control center is enabled to supply the information after both consumer and reader site registration (assuming the reader's fulfillment information already is available to control center). The information is supplied in accordance with the consumer's preferences (e.g., consumer designated location, such as e-mail address, consumer designated amount of information to be supplied, etc.). If, however, the fulfillment information is not yet available to the control center, then the control center may provide the consumer with an appropriate message and then, upon the control center receiving the appropriate fulfillment information, supply the fulfillment information to the consumer.

i. Product Purchase Option

As a feature of the present invention, and particularly applicable to the retail store embodiment described herein, the consumer and retail stores are enabled by the herein-described process to conduct commercial transactions either manually or automatically, as follows. During the previously discussed consumer registration process, the consumer is provided with various purchase options that concern the purchase of specified products relating to information that is included within fulfillment information provided to the consumer.

The following four purchase options are representative of what options may be available to the consumer:

(1) Automatic Purchase Option: This option is selected by a consumer who wants to automatically purchase the product that is associated with a respective reader that the consumer has allowed to read the consumer's card ID. Generally, a consumer supplied credit card or bank account information during registration will enable the automatic purchase option feature to be carried out. As previously discussed, a reader can be associated with an entire store, a department within a store, a group of products offer-for-sale by the store or an individual product. When the consumer has, during registration, selected the automatic purchase option (and supplied an appropriate payment method), then the consumer has pre-authorized purchase of an individual product that is associated with a reader when that reader reads the consumer's card ID. Upon selection of this option, the consumer can designate the manner of delivery (e.g., first class mail, Federal Express, etc.) and the location to which to deliver the purchased product. The automatic purchase option feature represents the most efficient method of purchasing a product that is associated with a reader.

(2) Ease of Purchase Option: This option can be selected to enable the consumer to readily, but not automatically, purchase a product that is identified in supplied fulfillment information. During registration, appropriate payment information (e.g., credit card number) and manner and location of delivery may be provided to facilitate this feature. Then, upon receipt of fulfillment information (e.g., by e-mail), the product(s) identified in the supplied fulfillment information may be readily purchased by selecting an identified product (e.g., by clicking on the product name itself in, for example, the e-mail message—which, for example, operates as a hyperlink to a designated web site to initiate the transaction). Purchase and delivery are automated upon such selection and various manners to accomplish this are well known in the art. If the fulfillment information is supplied by a manner other than via the Internet (e.g., via facsimile), then a unique code (representing both the product and the consumer) that is adjacent to the listed product may be supplied by the consumer to the control center (e.g., by e-mail, telephone, etc.) to automatically purchase the product. Other known manners of initiating a transaction may be utilized.

(3) Optional Purchase Option: This option is similar to option (2) above, but the consumer generally does not provide credit card information and/or manner/location of delivery during the registration process and, instead, supplies this information after receipt of fulfillment information and designation that a product is to be purchased.

(4) No Purchase Option: This option, selectable during registration, enables the consumer to indicate that the ID card is to be utilized only to receive information, and not to conduct commercial transactions. Thus, even if a retail store enables automatic or manual purchase of products via the control center (discussed below), consumer selection of the No Purchase Option during registration disables the purchase of products displayed within supplied fulfillment information. As can be appreciated, this feature may be desirable in the case when children are supplied with ID cards.

Analogous to the above possible options selectable by a consumer during consumer registration, the retail store, during reader site registration, is provided with various sell options pertaining to products identified in supplied fulfillment information.

The following four sell options are representative of what options may be available to the reader site:

(A) Automatic Sell Option: This option is analogous to the Automatic Purchase Option selectable by a consumer. Generally, if a particular card reader pertains to (i.e., is associated with) a specific product offered for sale by a store, and the store seeks to allow the product to be automatically purchased, then the Automatic Sell Option is selected during registration. The retail store will need to provide various information to enable the processing site (e.g., control center) to commence with the transaction, including, for example, the retail store's bank account into which monies are to be deposited. The fulfillment information should include information specific to the product for sale, such as its description and cost.

(B) Optional Sell Option: similar to (A) above, except the retail store would like to authorize the specific transaction prior to selling the product. This selectable option is independent of the purchase option selected by the consumer. Thus, even if the consumer selected the automatic purchase option, the transaction is not conducted until after the retail store authorizes the purchase, which may be achieved via e-mail, telephone, etc.

(C) No Sale Option: This option is selected during registration by the retail store if the fulfillment information being provided is intended only for informational purposes.

J. Multiple Purpose Card

In addition to the above features, the ID card of the present invention can be utilized to serve a second (or third, etc.) purpose. For example, the ID card can be utilized as an admission pass, either to one's residence or place or business, or to a third party site, such as an amusement park, trade show, concert, museum, etc.

The second purpose can itself be provided with additional features. For example, as an admission pass, the card can be date/time sensitive meaning that admission can occur only on a designated date or during a designated period of time. This additional information can be stored on the card itself or be stored at the control center.

The card can be utilized as a plane ticket and further can be utilized for the purpose of matching checked luggage to the cardholder, where the checked luggage contains a bar-code tag or other form of identification.

k. Loyalty Programs and Incentives

As a variation to the multiple purpose examples provided above, use of the ID card can be associated with various loyalty and incentive programs. With the herein-described retail store embodiment of the present invention, a loyalty program can provide a benefit or reward to a consumer upon use of the card a set number of times at a particular retail store or facility. The loyalty and incentive programs can be associated with use of an ID card at a particular group of stores, such as stores located on the same street or within a shopping mall.

As a variation of using a single card to obtain incentives, use of multiple cards (e.g., by a group of consumers) provides some benefit or incentive to that group.

l. Consumer Feedback

As a feature of the invention, upon receipt of fulfillment information by a consumer, the consumer is requested to supply so-called feedback information to the control center. The feedback information generally pertains to the fulfillment information supplied to the consumer and the amount of usefulness of that information. For example, in the retail store embodiment described herein, consumer supplied feedback information may pertain to the relative degree of general usefulness to the consumer, such as indicated on a scale or in terms supplied by the consumer. Other feedback information may pertain to whether the supplied information corresponded and/or was consistent with the previously supplied consumer preferences, such as whether too much information was provided when the consumer indicated a preference for minimal information. The manner of delivery of feedback information to the control center may be the same as the manner of delivery of the fulfillment information to the consumer. Of course, a different manner of delivery is possible.

The consumer supplied feedback information may pertain to services controlled or rendered by the control center or by the visited reader site. If for the visited reader site, then the control center may pass on such feedback information to the respective reader site or, alternatively, may compile useful information, such as recommendation information, that is then supplied to the reader site. In either case, anonymity of the consumer should be preserved unless otherwise authorized by the consumer.

m. Generation of Statistical Data

The present invention, by use of the process described herein, affords itself to the generation of statistical information that may be useful for various purposes. Statistical information may be generated by the control center that pertains to the reader site, to the control center or sponsor, to a government, or to another entity interested in such information. In the case of generating statistical information for use by one or more reader sites, the control center may maintain various statistical information about the number of “reads” per day (or month, year, etc.) by each reader, the number of “repeat” visits by consumers, geographical and demographic information of the consumers using cards on readers, etc. This statistical information then is provided to the reader sites to aid those sites in various business decisions. Statistical information also can be compiled which reflects reader sites relative to one another. For example, a reader site can be provided with statistical information showing the popularity of such site relative to other sites in close proximity or in the same or similar field of business.

Statistical information useful to a government, such as a state government, may include information that identifies the amount of “visits” to a region, based on card use, as compared to visits to other regions.

n. Various Modes of Operation of the ID Cards

As a feature of the invention, and to facilitate the complete efficiency and effectiveness of the herein-described process, the ID cards can be equipped to operate in a variety of operating modes, in which the cardholder optionally can manually set the ID card to operate. The following represents various exemplary modes of ID card operation:

(a) ON Mode: An ID card can operate in “on” mode in which the card's stored ID is automatically read by (or transmitted to) a reader in relatively close proximity to the card. Cards with magnetic strips thereon can be said to operate in such an “on” mode. Also, various RF transmitters operate in this “on” mode, such as those currently used by road toll systems to enable automobiles and other motor vehicles to automatically pay for tolls traveled through. In the case of ID cards in the form of RF transmitters and other types of contactless devices, a consumer can set his/her ID card to operate in the “on” mode and then come in relatively close proximity to a reader for the card's ID to be supplied automatically to the reader. One advantageous feature of this mode is enabling an ID card disposed within a case (e.g., a briefcase) or pocket to be read merely by placing the case or pocket in close proximity (e.g., 6 inches, 1 foot, 2 feet, etc., depending on the technology employed) to the reader.

(b) Manual Mode: A card can selectively operate in manual mode in which the holder needs to perform some task to enable the card's ID to be read by (or transmitted to) a reader. For example, a card operating in manual mode is read by a reader in close proximity upon depression of a button on the card. This mode may be desirable to enable a consumer to select specific readers that are passed to read the card's ID. Also, this mode enables the practical use of technology that allows for the transmission of a card ID at relatively large distances (e.g., 5 feet, 10 feet, 20 feet, etc.) while, at the same time, preventing unintended reads from occurring.

(c) Off Mode: A card operating in an off mode merely does not allow it's ID to be read by any device.

In accordance with the present invention, enabling consumer selection of card operation in one of the three above-described modes optimizes consumer efficiency by allowing the consumer to determine when his/her card ID is to be read.

2. Non-Retail Store Reader Sites

The previously described embodiments and features thereof pertain to retail stores and businesses and the sale of goods and services. The present invention, however, is not limited to only businesses offerings goods and services. In the non-retail store reader site embodiment of the present invention, readers are provided to other sites about which information may be desired. For example, readers can be provided to community centers, neighborhoods, apartment buildings, private homes, government buildings, landmarks, memorials and any other suitable location. Then, fulfillment information about the site is provided to a cardholder who has visited that site and decided to use his/her card at the site's reader to obtain further information. Such fulfillment information can be about the building itself, history of the location such as history of a town, village, city, etc., information about the occupants of the facility, information about individuals or other entities represented by the facility, as in the case of memorials, etc. This variation of the present invention may include the various features previously defined in sections a through n, if applicable.

3. Virtual Mailbox

The above-described embodiments of the present invention pertain to consumers and retail stores and other businesses offering goods and services for sale, and also to non-retail stores, such as previously discussed. In another embodiment of the present invention, the herein-described process is utilized to enable so-called “Virtual Mailboxes” which operate as electronic mail boxes for individuals, businesses, government entities and any other entity that receives information. The premise of the virtual mailbox embodiment of the present invention is the same as that previously described, the use of a card by a card holder at a reader site. In this embodiment, however, a reader site can correspond to a residence or any other location, including a business address, a government building, etc.

When a card holder “visits” a reader site and wishes to either obtain information about the reader site and/or wishes to leave his/her so-called “calling card” at the reader site, then the card holder uses the card—allows the card's ID to be read by the reader disposed at the reader site. Like the previously described embodiments, the card reader supplies the just read card ID and the reader's ID to the control center. The control center, in turn, supplies information to the cardholder in any manner previously described and also supplies information to the reader site about the cardholder. This information supplied back to the reader site generally includes the name and address of the card holder. Other information supplied may include telephone numbers, place of business, etc. The type and amount of information supplied by the control center to the reader site about the cardholder is defined by the cardholder during the previously described registration process. Similarly, the type and amount of information supplied to the cardholder about the reader site is defined by the reader site during the previously described reader site registration.

In addition to identifying the type and amount of information to be supplied by the control center to the reader site, the card can contain various buttons that correspond to previously selected “calling cards.” For example, the card can contain three buttons labeled “A,” “B,” and “C.” During registration, the cardholder can set the “A” button to correspond to the supply by the control center to the reader site of a substantial amount of information about the cardholder. “B” can then pertain to supplying less information, and “C” can pertain to supplying only a minimal amount of identification information, such as name and telephone number. Of course, various other arrangements may be possible. However, the above-described feature allows for the leaving of different types of “calling cards” in an easy and convenient manner.

The virtual mailbox embodiment of the present invention also may include the various features previously defined in the previous embodiments of the present invention.

The above-described retail store, non-retail store and virtual mailbox embodiments, and the variations thereof, can be applied to the travel industry where, for example, ID cards are distributed to passengers of airplanes (or buses, ships, etc.) travelling to tourist destinations. Consumers can receive pre-registered cards with their plane tickets (or the cards can be utilized as the plane tickets) or consumer can be provided with not-yet-registered cards upon departure or arrival to a destination site. The manner of use of these travel cards is the same as previously described.

4. Travel Cards

In a variation of the travel card embodiment of the present invention, passengers are supplied with ID cards that have been pre-registered to supply fulfillment information to the travel company (e.g., airline) to which the passengers are expected to return. For example, passengers of a cruise ship visiting a foreign port are supplied with ID cards where the fulfillment information is supplied to the cruise ship. Passengers then need only to identify their received ID cards to the cruise ship (or control center), which may be done before supply of the cards (such as providing each cabin with a card, with each cabin associated with the respectively supplied card) or after supply of the cards. Passengers then are provided with the fulfillment information upon their return to the cruise ship. As another example, fulfillment information can be supplied to the airplane to which a passenger is expected to return (e.g., when returning home from a trip).

The travel card embodiment of the present invention is of particular relevance with respect to visited historic and other sites of interest. The present invention enables travelers, not only to receive information about visited sites, but further enables those travelers to receive particular information uniquely of interest to travelers visiting foreign cities and other locations, such as photographs of the sites and a record of sites visited. For example, a tourist location may provide within the designated fulfillment information various photographs of the tourist location which, upon receipt by the cardholder, can be placed in, for example, the cardholder's photo-album. These photographs are easily provided in electronic form with any other fulfillment information, if communication to the cardholder from the control center is, for example, via the Internet.

In addition to providing photographs of visited sites, the present invention in its various embodiments, and especially in the travel cards embodiment, optionally provides to the cardholders with a record, such as in the form of a diary, of each site visited during the cardholder's travels.

5. Contained Environments—Trade Shows, Conventions and Fairs

Another application of the present invention is within so-called contained environments, such as trade shows, conventions, fairs and other events generally held at or within a single location. In this contained environment embodiment, the trade show attendees can be supplied with ID cards in any of the above-mentioned manners. For example, an attendee can pre-register to attend the show and then be provided with an ID card. An attendee can first obtain an ID card and then register. Also, registration can occur after or before the attendee begins using the card. In a preferred embodiment, each ID card also operates as an admission pass to the show. Alternatively, ID cards can be handed out to attendees at the show and after (or before) use of the cards attendees register, for example, at computers located at the show or utilizing a home or work computer or by calling a telephone number on the card. Thus, any of the previously mentioned methods of supplying ID cards and registration may be applied to the contained environment embodiment of the present invention.

Card readers may be distributed to the various businesses reserving space at the show (e.g., operating booths) in any manner previously discussed. Namely, booth operators can register (e.g., with the show operator) and then receive one or more card readers. Booth operators can also receive one or more card readers just prior to or during the show and thereafter register the readers. By distributing readers to booth operators, vendors and other businesses providing information and demonstrations at trade shows, fairs and other events, the present invention advantageously accommodates all “last minute” changes that may occur. As previously discussed, reader site registration can occur prior to or after use of the readers.

The present invention may be applied to other contained environments including so-called showrooms in which items for sale are displayed, such as car dealerships which typically display models of automobiles for sale. In such case, each model for sale is provided with a reader so that consumers can obtain information about only selected models. As another example, model homes may be equipped with one or more readers, with each optional home “upgrade” (e.g., an additional bathroom, upgraded type of floor, etc.) being provided with a reader.

6. Access and Security Systems

The present invention can be applied to entrance and security systems in a manner similar to that previously discussed in the virtual mailbox embodiment of the present invention. However, upon reading a cardholder's card ID, the control center verifies whether the cardholder should be given access to the reader site (e.g., the building at which the reader is located). If so, then the control center provides appropriate access information to the reader site to provide access to the cardholder. Various sites that can utilize such access and security systems includes residential homes, place of businesses, government buildings, etc.

7. Auctions

The present invention also can be applied to auctions in various manners.

Traditional Auctions

At so-called traditional auctions, where bidders place bids for items offered for sale, ID cards can be utilized to initiate a bid by respective bidders. In such case, multiple readers can be placed around the room in which the auction is taking place. In so-called secret auctions, multiple items for sale can be displayed with each item for sale having its own reader in which potential bidders secretly place a bid for the respective item simply by having his/her card ID read by the reader. As a feature, each reader (or a separate device located near the reader) displays the current highest bid amount and the bid increment, which can be selectable by the bidder. Or, the amount of the next bid to be placed is displayed by the reader or associated device.

Bidders can receive and register ID cards in any manner previously discussed. In the case when ID cards have been received but use occurs before registration, then the auction facility (and the control center) are not aware of the respective bidders until registered. Optionally, the auction can be implemented in this manner with complete anonymity of the bidder to the auction facility even after the auction and subsequent sale are completed. Also, readers can be distributed and utilized in any manner previously discussed. Thus, post auction reader registration accommodates last minute auction changes.

In any case previously mentioned, winners of auctions can be contacted via the control center in a manner similar to the supply of fulfillment information in the previously described embodiments.

Virtual Auctions

So-called virtual auctions are functionally the same as the previously mentioned traditional auction, but may be implemented to allow remote individuals to place bids, for example, via the Internet. In this variation, the present invention can be applied to allow bidders to bid from multiple locations on a single item for sale. For example, multiple reader sites (e.g., within different cities, etc.) can be set up to enable potential bidders located in different geographic areas to essentially “attend” a single auction. While various Internet sites have already enabled auctioning of goods to individuals utilizing the Internet, such as E-Bay and other known auction web sites, these web sites do not enable the implementation of traditional auctions that occur in a more tangible, physical form. The present invention allows the use of (physical) sites at geographically different locations and the use of ID cards in the manner previously discussed to enable the implementation of hybrid “traditional-virtual” auctions.

8. Concerts

The present invention can further be utilized within the concert-performing artist setting. In one variation, in the case when the event includes multiple performers, each performer (e.g., orchestra, rock group, singer, etc.) can be provided with readers to enable the attendees to obtain information about the performer in general, a particular compact disk (CD, or tape, album, etc.), or other information pertinent to the performer.

Various features previously discussed can be applied to the concerts embodiment of the present invention. For example, each ID card can operate as an admission pass. Consumer registration and/or reader site registration may occur before or after their use.

9. Locators

The present invention also may be applied to enable the determination of a cardholder's current location. For example, cards distributed to children (or the elderly, sick, etc.) can be utilized to keep track of a cardholder's location. The control center is enabled to provide location information to the cardholder's representative, guardian, etc. or to any third party since a cardholder's location can be determined based on the location of the readers that read the card ID.

As a feature of this application, so-called scan interval verification can be achieved by maintaining the location of a cardholder in the manner previously discussed and performing the additional function (by the control center or by a third party) of verifying that the cardholder has in a sense “verified” his/her current location at specified time intervals by having his/her card ID read by a reader. This application can be utilized to verify the location at specified time intervals of children, the disabled, the elderly, individuals under “house arrest,” etc. In the case of “house arrest” or individuals that require location monitoring, other features can be applied to ensure that it is the designated individual using his/her own ID card. For example, an ID card can be provided that only transmits its card ID (or otherwise allows the card ID to be read) when the designated user is holding the card. Currently, technology is available to read a person's fingerprints, or eye retina scan, to identify an individual. ID cards may include such technology and thus “operate” only when held by the authorized user or designated user. In such case, the technology of the card readers need not be concerned with the intended purpose of the read, whether to supply information or identify a location of an individual, or other purpose.

10. Obtaining Information about Cardholder

In another variation of the present invention, an ID card can be utilized to provide information about the cardholder to a third party. For example, a cardholder's medical history can be stored, for example, by the control center, and if necessary the cardholder's medical history can be retrieved by a third party such as a hospital by having the cardholder's card ID read by an appropriate reader. In this embodiment, the “fulfillment information” that is supplied back to the cardholder can pertain to medical information supplied by, for example, the hospital. Thus, the ID card does not operate solely for purposes of providing information to a third party, but operates to provide information generally about the third party to the cardholder and also about the cardholder to the third party. In the hospital example previously mentioned, the fulfillment information can be medical advice, prescription information or any other information that is useful to the cardholder. Thus, the substance of the information supplied back to the cardholder can be a function of both the facility visited by the cardholder (e.g., hospital, doctor's office, etc.) and information about the cardholder (e.g., medical history).

11. Entertainment

In addition to the embodiments, variations and applications previously mentioned, an ID card can be provided for the additional purpose of providing some form of entertainment to the cardholder. In this entertainment embodiment of the present invention, the ID card can be provided with additional technology to carry out such entertainment. For example, attendees at a rock concert or at an amusement park are provided with ID cards capable of emitting visible (or invisible) laser beams for the purpose of hitting “target” readers. Fulfillment information provided to the participants can include information about the recently conducted form of entertainment. Prizes also can be distributed within the fulfillment information.

The present invention has been described as various processes that occur utilizing various known technologies. Various embodiments, features and applications have also been discussed. It is to be appreciated that any of the features previously discussed, for example, with reference to the first-discussed retail store embodiment of the present invention, may be applied to any of the subsequently discussed embodiments and applications. For example, multiple manners of distribution and registration of ID cards have been discussed and multiple manners of distribution and registration of readers have also been discussed, including the possible process orders of registration followed by use, or use followed by registration, and each of these manners can be applied to any of the embodiments, features and applications discussed herein. The present invention also has been described as utilizing a number of technologies, such as magnetic cards, optical cards, cards with readable printable indicia thereon, RF and IR transmitters, etc., and the corresponding reader systems that are capable of reading a card's ID. However, the present invention is not limited solely to the technologies identified herein and embodies other technologies that can be utilized, whether or not currently available. Moreover, the present invention has been described as including a number of communications between various devices, including the reader and the control center, and between the control center and the cardholder identified device (e.g., e-mail address, facsimile machine, personal digital assistant (PDA), etc.) Such methods of communication identified herein represent exemplary methods and, thus, the present invention should not be construed to embody only those manners discussed. Finally, the multiple processes and applications described herein involve the use of generic types of ID cards and card readers, that is, the cards and readers need not necessarily be designed and adapted to a particular embodiment or application Thus, an ID card intended for use in one particular application or embodiment is easily usable, without any modification or with minimal modification, within other applications or embodiments. Likewise, a card reader intended for use in one particular application or embodiment is easily usable, without any modification or minimal modification, within other applications and embodiments. Also, the manners of communication between the reader site and the control center and between the control center and the cardholder is independent of the particular applications involved. Of course, the particular fulfillment information that is to be supplied to the cardholder is specific to the particular reader site and the particular information that is sought to be delivered by that reader site. Thus, the present invention allows for the implementation of various and diverse applications of a process without the need for different technical requirements.

Therefore, it is intended that the appended claims be interpreted as including the embodiments described herein, the alternatives mentioned above, and all equivalents thereto.

What is claimed is:

1. A system for supplying information between a visited physical location and a user of a portable device, comprising:
a portable device supplied to and adapted to be carried by a human being user, the portable device having a unique device identification code;
a reader adapted to read the device identification code of the portable device of the user in close proximity to the reader, the reader being associated with a physical location to be visited by the user and having a unique reader identification code, the reader including capability to supply as an output the device identification code of the portable device when read along with the reader identification code of the reader;
a control center receiving user identification information identifying an identity of the user and associating the user identification information with the device identification code of the portable device supplied to the user; the control center receiving reader identification information identifying an identity of the occupant of the physical location and associating the received reader identification information with the reader identification code of the reader associated with the physical location; the control center adapted to receive the device identification code and the reader identification code output by the reader, the control center supplying information associated with the supplied reader identification code to a user information destination associated with the received device identification code and supplying to the physical location the identity of the user associated with the supplied device identification code.

2. The system of claim 1, wherein the reader is adapted to read the device identification code of the portable device when the portable device is exterior to the physical location.

3. The system of claim 1, wherein the reader is adapted to read the device identification code of the portable device when the physical location is closed.

4. The system of claim 1, wherein the portable device supplied to the user does not directly identify the user.

5. The system of claim 1, further comprising a plurality of readers disposed within or near the physical location, each of the readers being disposed at a respective unit within or associated with the physical location and having a respective reader identification code.

6. The system of claim 1, wherein the control center receives from the user a preferred amount of identification information to be supplied to visited locations; and the control center supplies to the physical location the identity of the user associated with the supplied device identification code in accordance with the preferred amount of identification information to be supplied.

7. The system of claim 1, wherein the control center receives from the user a plurality of amounts of identification information to be supplied; the portable device includes means for selecting one of the plurality of amounts of identification information to be supplied during a visit to a physical location; and the control center supplies to the physical location the identity of the user associated with the supplied device identification code in accordance with the selected one of the plurality of amounts of identification information to be supplied.

8. A process of supplying information between a visited physical location and a user of a portable device, comprising the steps of:
providing to a user a portable device having a device identification code stored on or in the portable device;
associating an identity of the user with the device identification code of the portable device;
disposing a reader within or near a physical location, the reader having an associated reader identification code;
visiting by the user of the physical location;
reading by the reader of the device identification code stored on or in the portable device;
supplying to a control center the reader identification code and the device identification code of the portable device read by the reader; and
supplying by the control center to the physical location the identity of the user associated with the supplied device identification code.

9. The process of claim 8, further comprising the steps of identifying by the user of an information destination to which information is to be supplied to the user; associating the identified information destination with the device identification code of the portable device provided to the user; identifying to the control center information associated with the reader identification code and relating to the physical location; and supplying by the control center the information associated with the supplied reader identification code to the information destination associated with the supplied device identification code.

10. The process of claim 8, wherein the step of visiting is carried out by visiting an exterior of the physical location; and the reading step is carried out when the user is exterior to the physical location.

11. The process of claim 8, wherein the step of visiting is carried out by visiting by the user of the physical location when the physical location is closed; and the reading step is carried out when the physical location is closed.

12. The process of claim 8, wherein the portable device supplied to the user does not identify the user.

13. The process of claim 8, wherein the step of disposing the reader within or near the physical location is carried out by disposing a plurality of readers within or near the physical location, each of the readers being disposed at a respective unit within or associated with the physical location and having a respective reader identification code.

14. The process of claim 8, further comprising the step of registering the user to the control center during which the user identifies an amount of identification information to be supplied to visited locations; and wherein the step of supplying by the control center is carried out by supplying to the physical location the identity of the user associated with the supplied device identification code in accordance with the user identified amount of identification information to be supplied.

15. The process of claim 14, wherein the step of registering includes the user identifying a plurality of amounts of identification information to be supplied; the process further comprising the step of identifying by the user during the visiting step one of the plurality of amounts of identification information to be supplied; and wherein the step of supplying by the control center is carried out by supplying to the physical location an amount of identification information in accordance with the user identified one of the plurality of amounts of identification information to be supplied.
